(19) United States
(12) Patent Application Publication
(10) Pub. No.: US 2015/0165603 A1
(43) Pub. Date: Jun. 18, 2015

(54) POWER DEVICE WITH A UNICORN IMPACT UNIT

(71) Applicant: Ming-Ta Cheng, Taichung City (TW)

(72) Inventor: Ming-Ta Cheng, Taichung City (TW)

(21) Appl. No.: 14/109,120

(22) Filed: Dec. 17, 2013

(51) Int. Cl. B25B 21/02; B25B 21/00

(52) U.S. Cl. CPC B25B 21/02; B25B 21/004

(57) ABSTRACT

A power device with a unicorn impact unit includes a handle, a housing, an impact unit and ratchet unit. The handle has a front end and a motor mounted at the front end and has a driving shaft. The housing is mounted at the front end of the handle and is sleeved around the motor has a rotation chamber formed inside the housing. The impact unit is rotatably mounted in the rotation chamber and has a mounting seat, a hammer and an anvil shaft. The anvil shaft inserts into the hammer and is mounted on the mounting seat. The ratchet unit is mounted in the rotation chamber, is connected with anvil shaft. The impact unit only effect toward one direction when rotating, so the handle has no necessary to set a button for switching rotation directions of motor and the design of the handle can be simplified.

### BACKGROUND OF THE INVENTION

1. Field of the Invention

The present invention relates to a power tool and more particularly to a power device with a unicorn impact unit.

2. Description of Related Art

A conventional power device provides power to screw a bolt or a nut tightly or loosely and driven by air pressure or electricity. The power device is already instead of handwork.

With reference to FIG. 9, a conventional power device has an impact unit 60. The impact unit 60 includes a mounting seat 61, a hammer 62 and a shaft 63. The mounting seat 61 has two sides, a space 611 and a central hole 612. The space 611 is longitudinally formed in middle of the mounting seat 61. The central hole 612 is formed through two sides of the mounting seat 61 and communicates with the space 611. The hammer 62 is mounted in the space 611 of the mounting seat 61 and has an opening 621 and an impact face 622. The opening 621 is maple-shaped, is formed through the hammer 62 and aligns with the central hole 612. The impact face 622 is defined inside of the opening 621. The shaft 63 is rotatably mounted through the central hole 612 and the opening 621 and has an anvil portion 631 against to the impact face 622.

The impact unit 60 in use has following shortcomings:

1. The conventional power device usually set a ratchet unit which can switch rotation direction by a button, and the impact unit 60 also can switch rotation direction by a motor. The conventional power device has two devices, the ratchet unit and the impact unit 60, which have same function for switching rotation direction. Using two devices providing the same function is unnecessary and also causes the high costs of produces.

2. The opening 621 is maple-shaped and hard to produce. Two sides of the opening 621 are sharp so that structures beside the opening 621 are fragile, weak and not endurable and also increase the costs of produces.

3. The shaft 63 is elongated and is formed integrated so that the shaft 63 is easily bent or deformed by impact effect and needs to be replaced frequently.

To overcome the shortcomings of the conventional power device, the present invention provides a power device with a unicorn impact unit to mitigate or obviate the aforementioned problems.

### SUMMARY OF THE INVENTION

The main objective of the invention is to provide a power device with a unicorn impact unit; the power device with a unicorn impact unit includes a handle, a housing, an impact unit and ratchet unit.

The handle has a front end and a motor mounted at the front end and has a driving shaft.

The housing is mounted at the front end of the handle and is mounted around the motor and has a rotation chamber formed inside the housing and a tool hole transversely formed through at one end of housing.

The impact unit is rotatably mounted in the rotation chamber and has a mounting seat, a hammer and an anvil shaft.

The mounting seat is rotatably connected with the driving shaft and has a space.

The hammer is swingably mounted in the space of the mounting seat and outstretched a top and a bottom of the periphery of the mounting seat, the hammer has an opening centrally formed through the hammer, a notch and a unicorn flange defined inside the opening and located adjacent to each other.

The anvil shaft inserts into the opening and is mounted on the mounting seat and has an anvil portion and an eccentric portion. The anvil portion and the eccentric portion are respectively formed on two end of the anvil shaft and located opposite to each other. An abutting protrusion protrudes from one end of the anvil portion. An eccentric shaft protrudes from one end of the eccentric portion.

When the hammer rotates toward a rotation direction, the unicorn flange selectively contacts the abutting protrusion and drive to the anvil shaft rotating; when the hammer rotates reversely, the unicorn flange will not to contact the abutting protrusion and not to rotate the anvil shaft.

The ratchet unit is mounted in the rotation chamber, is connected with anvil shaft and protrudes out from the tool hole, the ratchet unit has an adjusting button and a working tool mounted opposite to each other.

Other objects, advantages, and novel features of the invention will become more apparent from the following detailed description when taken in conjunction with the accompanying drawing.

### BRIEF DESCRIPTION OF THE DRAWINGS

FIG. 1 is a cross-section perspective view in partial section of a power device with a unicorn impact unit in accordance with the present invention;

FIG. 2 is an exploded perspective view of a handle and an impact unit of the power device in FIG. 1;

FIG. 3 is an exploded perspective view of the impact unit of the power device in FIG. 1;

FIG. 4 is an enlarged perspective view in partial section of an anvil shaft of the impact unit in FIG. 3;

FIG. 5 is an operational cross-section front view of impact unit in clockwise rotating status in FIG. 1;

FIG. 6 is an operational cross-section front view of impact unit in counter-clockwise rotating status in FIG. 1;

FIG. 7 is a cross-section perspective view in partial section of a second embodiment of the power device with a unicorn impact unit in accordance with the present invention;

FIG. 8 is an exploded perspective view of the impact unit of the power device in FIG. 7;

FIG. 9 is an exploded perspective view of conventional impact unit.

### DETAILED DESCRIPTION OF PREFERRED EMBODIMENT

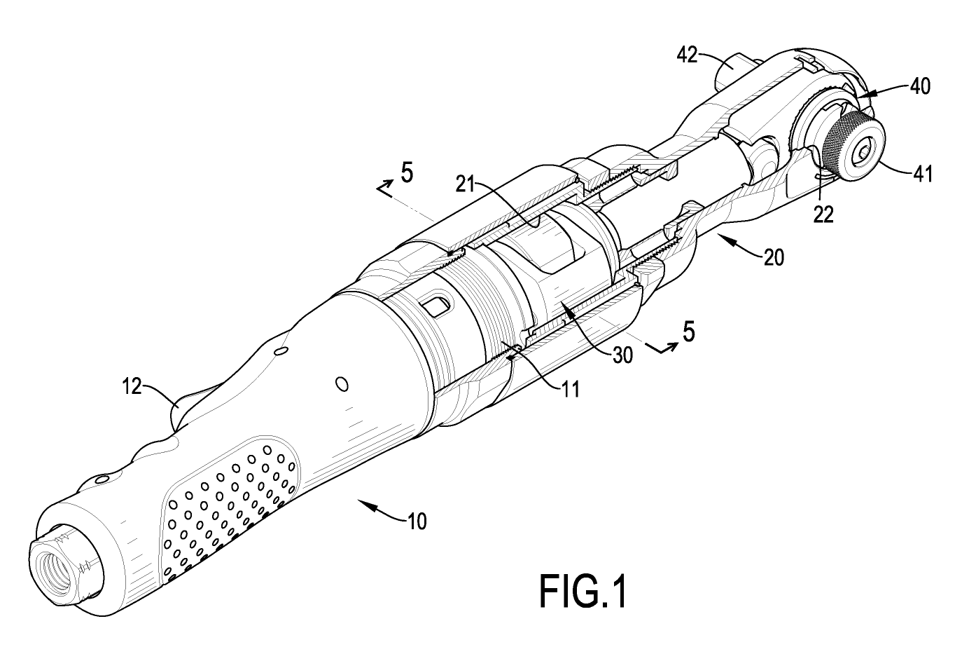

With reference to FIG. 1, a preferred embodiment of a power device with a unicorn impact unit in accordance with the present invention has a handle 10, housing 20, an impact unit 30 and ratchet unit 40.

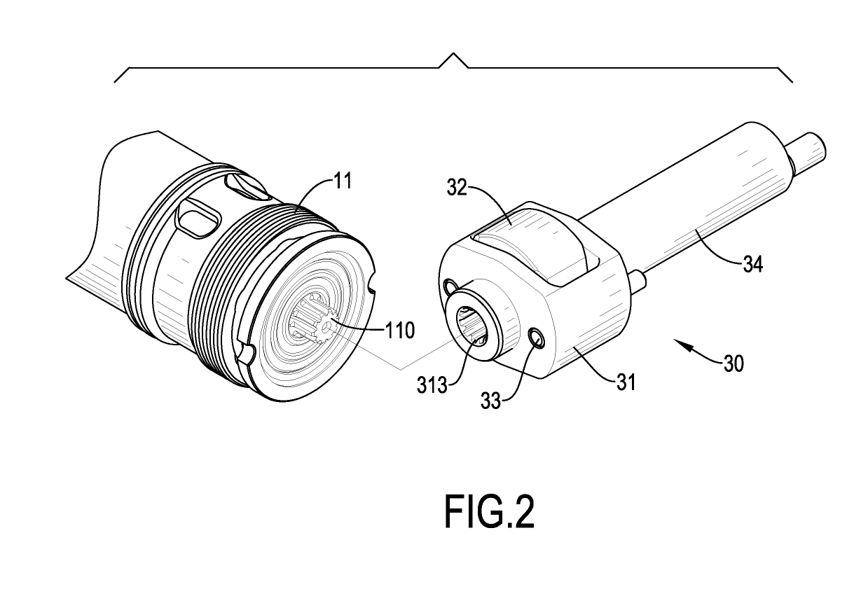

With reference to FIGS. 1 and 2, the handle 10 has a front end, a motor 11 and a button 12. The motor 11 is mounted at the front end and has a driving shaft 110. A gear face is formed around an outer wall of the driving shaft 110. The button 12 is mounted on an outer wall of the handle 10 and can be pressed to drive the motor 11 rotating.

With reference to FIG. 1, the housing 20 is mounted at the front end of the handle 10 and is mounted around the motor 11. The housing 20 is hollow, is assembled by multiple shells and has a rotation chamber 21 and a tool hole 22. The rotation chamber 21 is formed inside the housing 20. The tool hole 22 is transversely formed through a distal end of the housing 20 which is far away the handle 10.

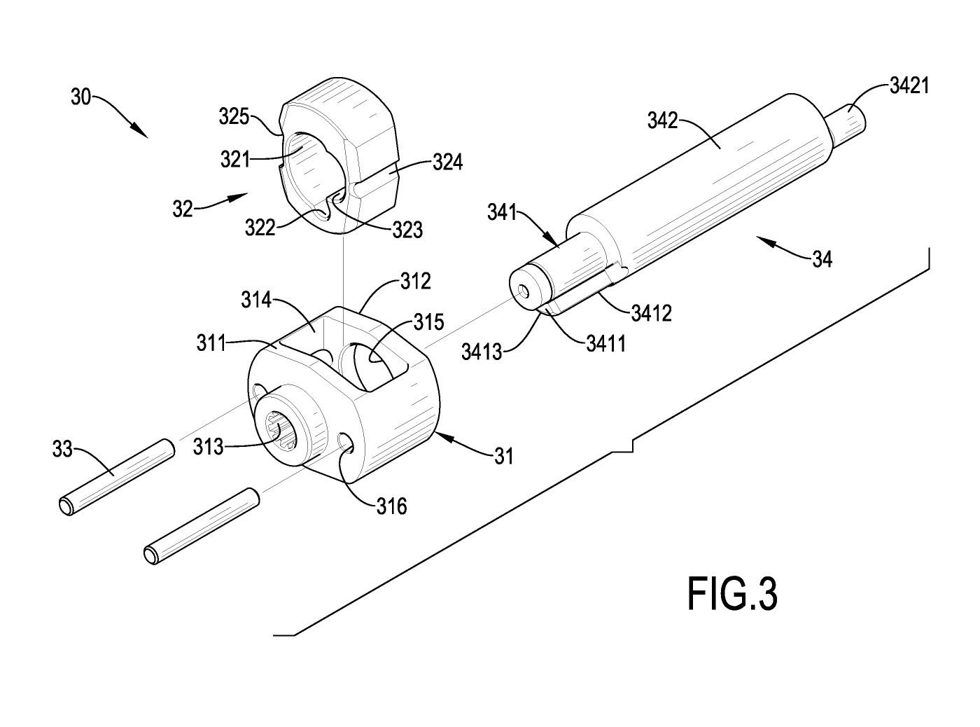

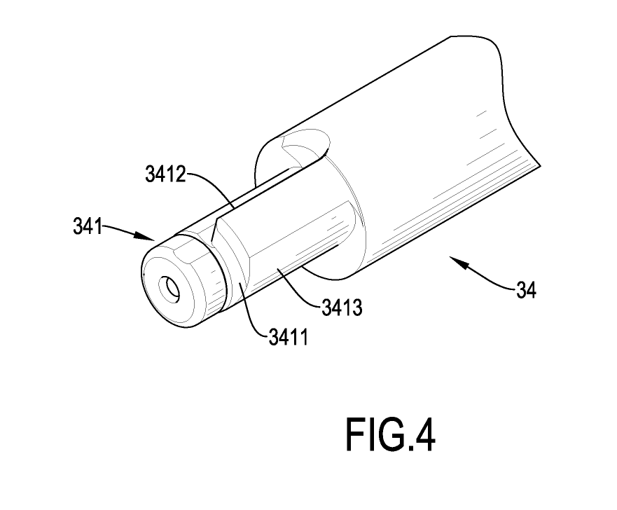

With reference to FIGS. 2 and 3, the impact unit 30 is rotatably mounted in the rotation chamber 21 and has a mounting seat 31, a hammer 32, two pivot rods 33 and an anvil shaft 34. The mounting seat 31 is mounted adjacent to the handle 10, is connected with the motor 11. The mounting seat 31 has a connecting board 311, a fixing board 312, an engage hole 313, a space 314, a shaft hole 315 and two rod holes 316. The connecting board 311 and fixing board 312 are arranged axially and are parallel each other. The engage hole 313 is a gear hole, is centrally formed on the connecting board 311 and engages the gear face of the driving shaft 110. The space 314 is defined between the connecting board 311 and fixing board 312. The shaft hole 315 is centrally formed on the fixing broad 312 and is coaxial with the engage hole 313. The rod holes 316 are coaxially formed through the connecting board 311 and fixing board 312 and are respectively located in both side of the mounting seat 31.

With reference to FIGS. 2 and 3, the hammer 32 is a rectangular block and is swingably mounted in the space 314 and is outstretched a top and a bottom of a periphery of the mounting seat 31. The hammer 32 has a first outside wall, a second outside wall, an opening 321, a notch 322, a unicorn flange 323, a rod recess 324 and a movable recess 325. The first and second outside wall of the hammer 32 are opposite to each other. The opening 321 is centrally formed through the hammer 32. The inner surface of the opening 321 consists of two curved-surfaces that have different radius and are connected each other. The notch 322 and the unicorn flange 323 are defined inside the opening 321 and are formed adjacent to each other. The notch 322 is formed adjacent at one of a boundary of the two curved-surfaces. The rod recess 324 is semi-circular in cross section and is formed on the first outside wall of the hammer 32. The movable recess 325 is formed on the second outside wall of the hammer 32 and is opposite to and is wider than the rod recess 324.

The pivot rods 33 are respectively inserted in the two rod holes 316 and are respectively mounted in the rod recess 324 and the movable recess 325. The hammer 32 can be pivoted with taking the pivot rod 33 in the rod recess 324 as a pivot and the movable recess 325 and the pivot rod 33 therein sliding relatively.

The anvil shaft 34 is formed integratedly, inserts from the shaft hole 315 to engage hole 313 via the opening 321 and has an anvil portion 341 and an eccentric portion 342. An abutting protrusion 3411 is formed on one end of the anvil portion 341 and has a sharp edge 3412 and a round edge 3413. The sharp edge 3412 has acute angle and is opposite to the round edge 3413. The anvil portion 341 is inserted in the opening 321 and the sharp edge 3412 and correspondingly abuts the unicorn flange 323. Therefore, the motor 11 drives the mounting seat 31 and the anvil shaft 34, and then the anvil portion 341 contacts the opening 321 to move the hammer 32 repeatedly. The eccentric portion 342 is opposite to the anvil portion 341 and has an eccentric shaft 3421 protruding from one end of the eccentric portion 342.

With reference to FIG. 1, the ratchet unit 40 is connected with and is driven by the anvil shaft 34, is mounted in the rotation chamber 21 and protrudes out from the tool hole 22. The ratchet unit 40 is used for removing or installing bolts or nuts. The ratchet unit 40 has an adjusting button 41 and a working tool 42 mounted opposite to each other. The working tool 42 is detachably and can switch rotation directions by the adjusting button 41.

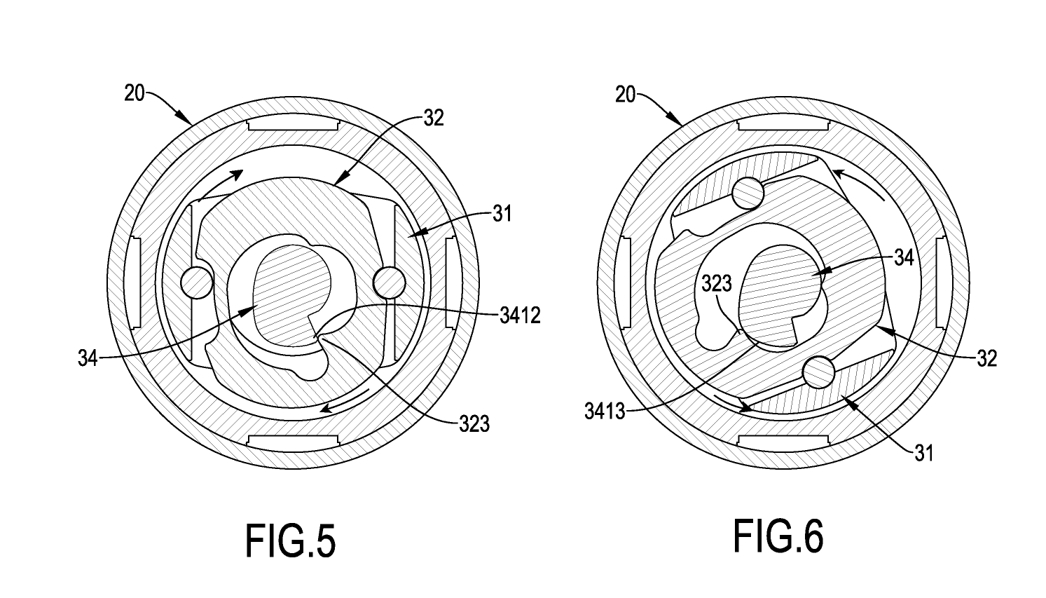

With reference to FIG. 1, a user can hold the handle 10 and press the button 12 to drive the motor 11, and then the mounting seat 31 will be rotated by the motor 11. With reference to FIG. 5, when the motor 11 rotates clockwise, the mounting seat 31 rotates toward same direction with the motor 11 and drives the hammer 32 together. Due to the mounting seat 31 rotating, the hammer 32 is swung repeatedly and make the unicorn flange 323 engage the sharp edge 3412 of the anvil portion 341. Thus, the anvil shaft 34 is rotated by the hammer 32 and generates torsion to drive the ratchet unit 40 for removing or installing bolts or nuts.

If the bolts or the nuts already have screwed by the ratchet unit 40, the torsion from the bolts or the nuts is larger than torsion of the impact unit 30. Thus, the hammer 32 does not have enough torsion to push the anvil shaft 34 and will slip form the anvil shaft 34. Therefore, the anvil shaft 34 will stop to rotate the ratchet unit 40 and avoids the bolts or the nuts locked.

With reference to FIGS. 1 and 6, when the motor 11 rotates counterclockwise, the anvil shaft 34 cannot be rotated by the hammer 32 because the notch 322 and the unicorn flange 323 cannot engage the round edge 3413 of the anvil shaft 34. Consequently, the ratchet unit 40 will not be rotated by the impact unit 30 when the motor 11 rotates counterclockwise.

In addition, the special design of the unicorn flange 323 makes the hammer 32 only receiving impact force from one direction, and provides thickly and strongly structure for hammering and decreases the cost of produces and increases the life of the product.

The impact unit 30 only effect toward one direction when rotating, so the handle 10 has no necessary to set a button for switching rotation directions of motor. Also, the adjusting button 41 of the ratchet unit 40 can switch rotation directions of the working tool 42 directly and the design of the handle 10 can be simplified.

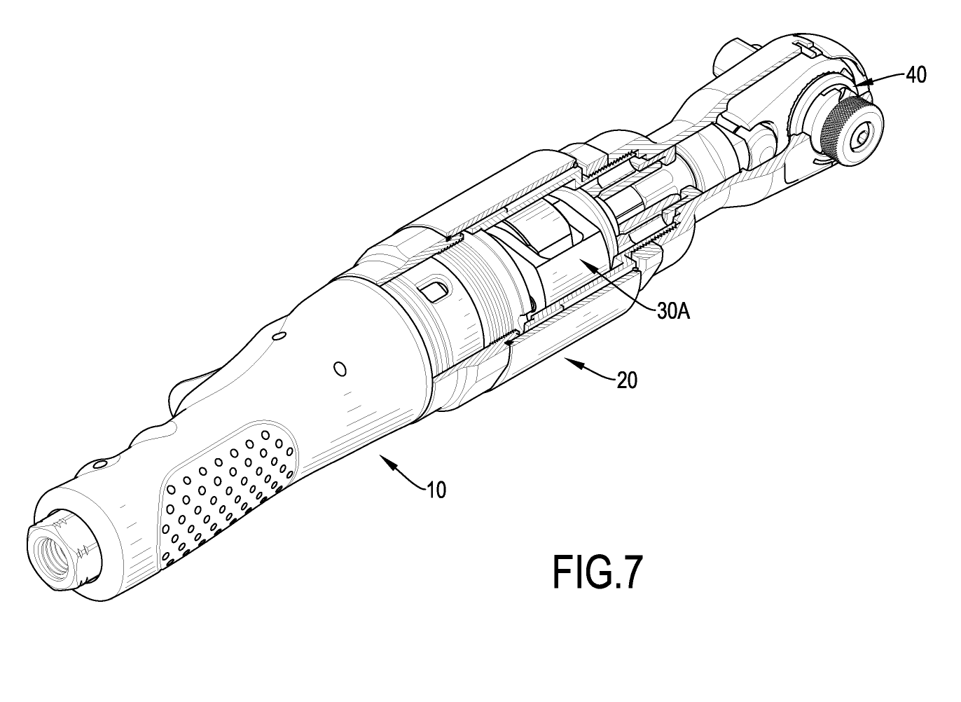

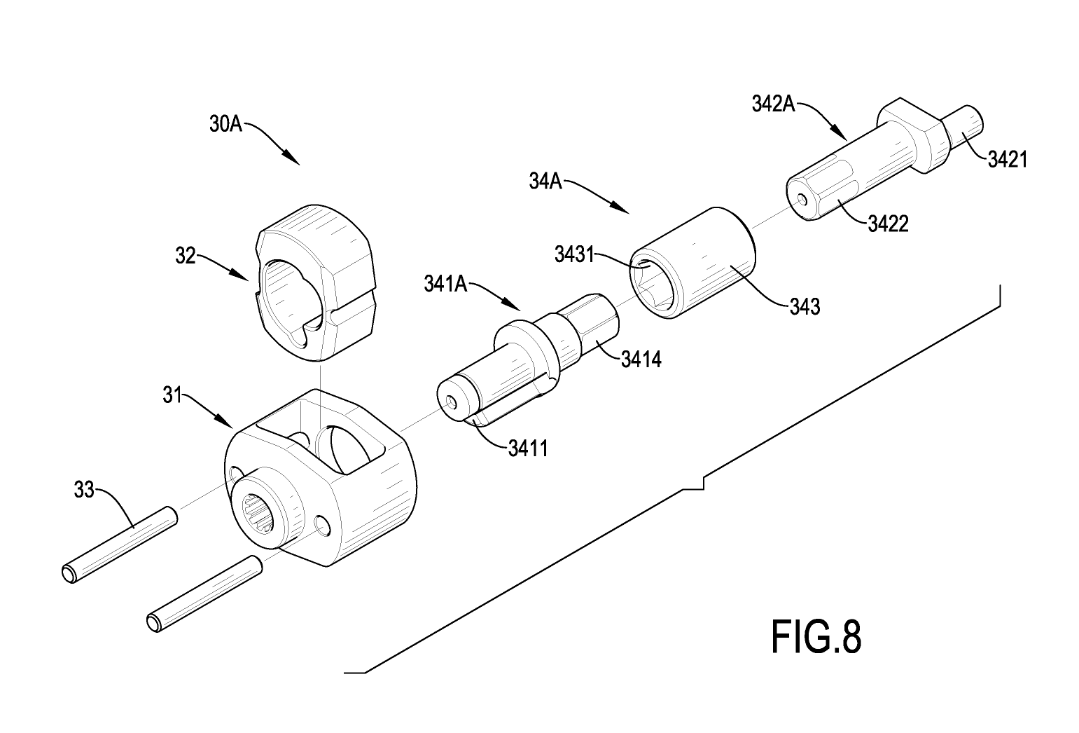

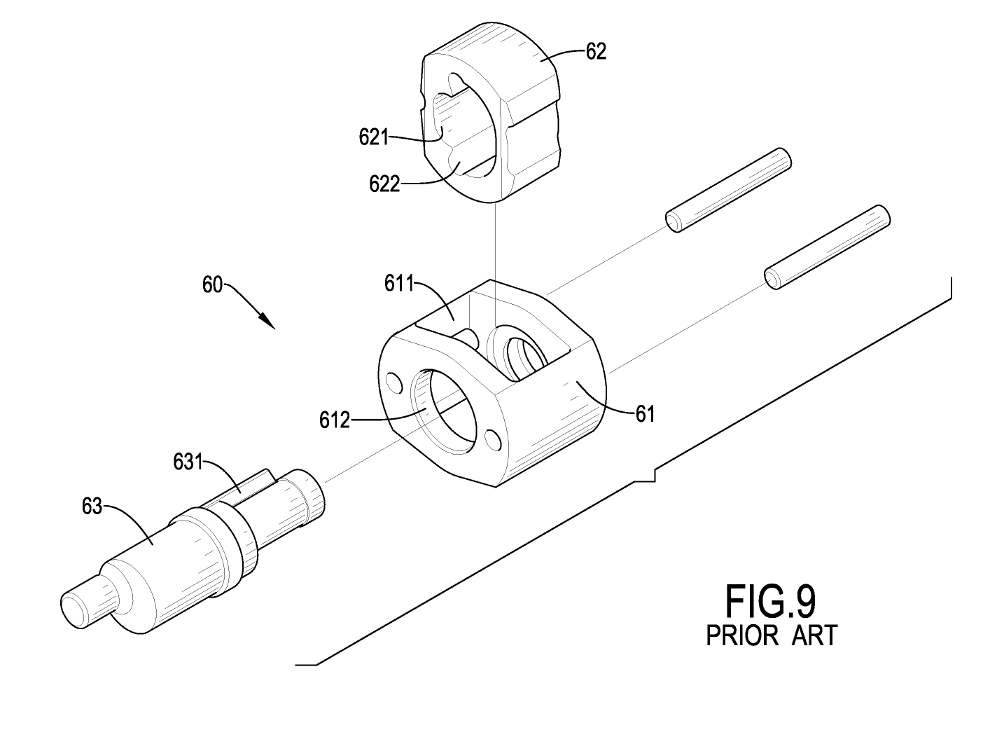

With reference to FIGS. 7 and 8, in a second embodiment of a power device with a unicorn impact unit in accordance with the present invention, the elements and effects of the second embodiment are same with those of the first embodiment except the anvil shaft 34A of the impact unit 30A is detachable. The anvil shaft 34A has an anvil portion 341A, an eccentric portion 342A and a connecting tube 343. The anvil portion 341A has an abutting protrusion 3411 and a first assembling portion 3414 located opposite the abutting protrusion 3411. The eccentric portion 342A has an eccentric shaft 3421 and a second assembling portion 3415 located opposite the eccentric shaft 3421. The first assembling portion 3414 and the second assembling portion 3415 are polygonal in cross-section. The connecting tube 343 is connected with the anvil portion 341A and the eccentric portion 342A and has two assembling recesses 3431. The assembling recesses 3431 are polygonal in cross-section and are formed on two side of the connecting tube 343. The assembling recesses 3431 are respectively and correspondingly mounted on the first assembling portion 3414 and second assembling portion 3415.

Thereby, when the anvil shaft 34A is bent or deformed by impact force, the anvil portion 341A or the eccentric shaft 3421 can be replaced separately and partially and not necessary to replace whole anvil shaft 34A which reduce the costs of replacement.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power device with a unicorn impact unit comprising:
a handle having
a front end;
a motor mounted at the front end of the handle and having a driving shaft;
a housing mounted at the front end of the handle and mounted around the motor having
a rotation chamber formed inside the housing;
a tool hole transversely formed through at one end of housing;
an impact unit rotatably mounted in the rotation chamber and having
a mounting seat rotatably connected with the driving shaft and having a space;
a hammer swingably mounted in the space of the mounting seat and outstretched a top and a bottom of a periphery of the mounting seat, the hammer having an opening centrally formed through the hammer, a notch and an unicorn flange defined inside the opening and located adjacent to each other;
an anvil shaft inserting into the opening and mounted on the mounting seat and having an anvil portion and an eccentric portion, the anvil portion and the eccentric portion respectively formed on two end of the anvil shaft and located opposite to each other, an abutting protrusion protruding from one end of the anvil portion, an eccentric shaft protruding from one end of the eccentric portion;
when the hammer rotating toward a rotation direction, the unicorn flange selectively contacting the abutting protrusion and driving the anvil shaft rotating; when the hammer rotating reversely, the unicorn flange will not to contact the abutting protrusion and not to rotate the anvil shaft; and
a ratchet unit mounted in the rotation chamber, connected with anvil shaft and protruding out from the tool hole, the ratchet unit having an adjusting button and a working tool mounted opposite to each other.

2. The power device with a unicorn impact unit as claimed in claim 1, wherein the opening has an inner surface, the inner surface consists of two curved-surfaces that have different radius and are connected each other.

3. The power device with a unicorn impact unit as claimed in claim 2, wherein the abutting protrusion has a sharp edge and a round edge, the sharp edge is opposite to the round edge.

4. The power device with a unicorn impact unit as claimed in claim 1, wherein the anvil shaft is formed integratedly.

5. The power device with a unicorn impact unit as claimed in claim 2, wherein the anvil shaft is formed integratedly.

6. The power device with a unicorn impact unit as claimed in claim 3, wherein the anvil shaft is formed integratedly.

7. The power device with a unicorn impact unit as claimed in claim 1, wherein the anvil shaft is detachable, the anvil shaft further includes a connecting tube which is connected with the anvil portion and the eccentric portion.

8. The power device with a unicorn impact unit as claimed in claim 2, wherein the anvil shaft is detachable, the anvil shaft further includes a connecting tube which is connected with the anvil portion and the eccentric portion.

9. The power device with a unicorn impact unit as claimed in claim 3, wherein the anvil shaft is detachable, the anvil shaft further includes a connecting tube which is connected with the anvil portion and the eccentric portion.

10. The power device with a unicorn impact unit as claimed in claim 7, wherein
the anvil portion further has a first assembling portion located opposite the abutting protrusion;
the eccentric portion further has a second assembling portion located opposite the eccentric shaft;
the connecting tube has two assembling recesses formed on two side of the connecting tube, the assembling recesses are respectively mounted on the first assembling portion and second assembling portion.

11. The power device with a unicorn impact unit as claimed in claim 8, wherein
the anvil portion further has a first assembling portion located opposite the abutting protrusion;
the eccentric portion further has a second assembling portion located opposite the eccentric shaft;
the connecting tube has two assembling recesses formed on two side of the connecting tube, the assembling recesses are respectively mounted on the first assembling portion and second assembling portion.

12. The power device with a unicorn impact unit as claimed in claim 9, wherein
the anvil portion further has a first assembling portion located opposite the abutting protrusion;
the eccentric portion further has a second assembling portion located opposite the eccentric shaft;
the connecting tube has two assembling recesses formed on two side of the connecting tube, the assembling recesses are respectively mounted on the first assembling portion and second assembling portion.

13. The power device with a unicorn impact unit as claimed in claim 10, wherein the first assembling portion, the second assembling portion and the assembling recesses are polygonal in cross-section.

14. The power device with a unicorn impact unit as claimed in claim 11, wherein the first assembling portion, the second assembling portion and the assembling recesses are polygonal in cross-section.

15. The power device with a unicorn impact unit as claimed in claim 12, wherein the first assembling portion, the second assembling portion and the assembling recesses are polygonal in cross-section.
